(19) United States
(12) Patent Application Publication
(10) Pub. No.: US 2025/0305430 A1
(43) Pub. Date: Oct. 2, 2025

(54) VENTILATION SYSTEM FOR FORCED-INDUCTION ENGINE

(71) Applicant: TOYOTA JIDOSHA KABUSHIKI KAISHA, Toyota-shi (JP)

(72) Inventor: Toru SAKUMA, Toyota-shi (JP)

(21) Appl. No.: 19/055,508

(22) Filed: Feb. 18, 2025

(30) Foreign Application Priority Data
Mar. 26, 2024 (JP) 2024-049828

(51) Int. Cl. F01M 13/04

(52) U.S. Cl. CPC F01M 13/0416; F01M 2013/0494

(57) ABSTRACT

A ventilation system for a forced-induction engine is provided. A first passage connects a downstream intake portion to a crankcase to ventilate the crankcase. The second passage connects an upstream intake portion to the crankcase. An oil separator is provided in the second passage. A third passage connects the downstream intake portion to the oil separator. A check valve that restricts a flow of gas from the oil separator toward the downstream intake portion through the third passage.

### CROSS-REFERENCE TO RELATED APPLICATIONS

This application is based upon and claims the benefit of priority from Japanese Patent Application No. 2024-049828, filed on Mar. 26, 2024, the entire contents of which are incorporated herein by reference.

### BACKGROUND

### 1. Field

The present disclosure relates to a ventilation system for a forced-induction engine.

### 2. Description of Related Art

Conventionally, a blow-by gas ventilation system is known, as disclosed in Japanese Laid-Open Patent Publication No. 2008-111422. This blow-by gas ventilation system includes a first passage and a second passage. The first passage connects a section of the intake passage that is downstream of the intercooler to the crankcase. The second passage connects a section of the intake passage that is upstream of the compressor to the crankcase.

In the above-described ventilation system, during a forced-induction operation of the forced-induction engine, intake air pressurized by the compressor is introduced into the crankcase through the first passage. The pressure of the introduced intake air forces the blow-by gas inside the crankcase to be expelled and recirculated to the intake passage via the second passage. Consequently, the crankcase is ventilated. The second passage of the ventilation system is equipped with an oil separator. The oil separator separates oil from the blow-by gas recirculated to the intake passage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a ventilation system for a forced-induction engine includes a first passage that connects an intake passage of the forced-induction engine to a crankcase. The forced-induction engine includes a compressor provided in the intake passage. The intake passage includes an upstream intake portion upstream of the compressor and a downstream intake portion downstream of the compressor. A throttle valve is provided in the downstream intake portion. The first passage connects the downstream intake portion to the crankcase to ventilate the crankcase. A second passage connects the upstream intake portion to the crankcase. An oil separator is provided in the second passage. A third passage connects the downstream intake portion to the oil separator. A check valve restricts a flow of gas from the oil separator toward the downstream intake portion through the third passage.

The ventilation system for the forced-induction engine has an effect of suppressing the occurrence of emulsion.

The blow-by gas in the crankcase contains moisture. In a general ventilation system, when the oil separator separates oil, if moisture in the blow-by gas is mixed into the oil, emulsion may be generated. The above configuration suppresses this possibility.

Other features and aspects will be apparent from the following detailed description, the drawings, and the claims.

### BRIEF DESCRIPTION OF THE DRAWINGS

FIG. 1 is a diagram schematically showing a ventilation system for a forced-induction engine according to an embodiment.

FIG. 2 is a diagram showing the flow of gas in the ventilation system during a natural aspiration operation of the forced-induction engine shown in FIG. 1.

FIG. 3 is a diagram showing the flow of gas in the ventilation system during a forced-induction operation of the forced-induction engine shown in FIG. 1.

FIG. 4 is a diagram schematically showing a ventilation system for a forced-induction engine according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

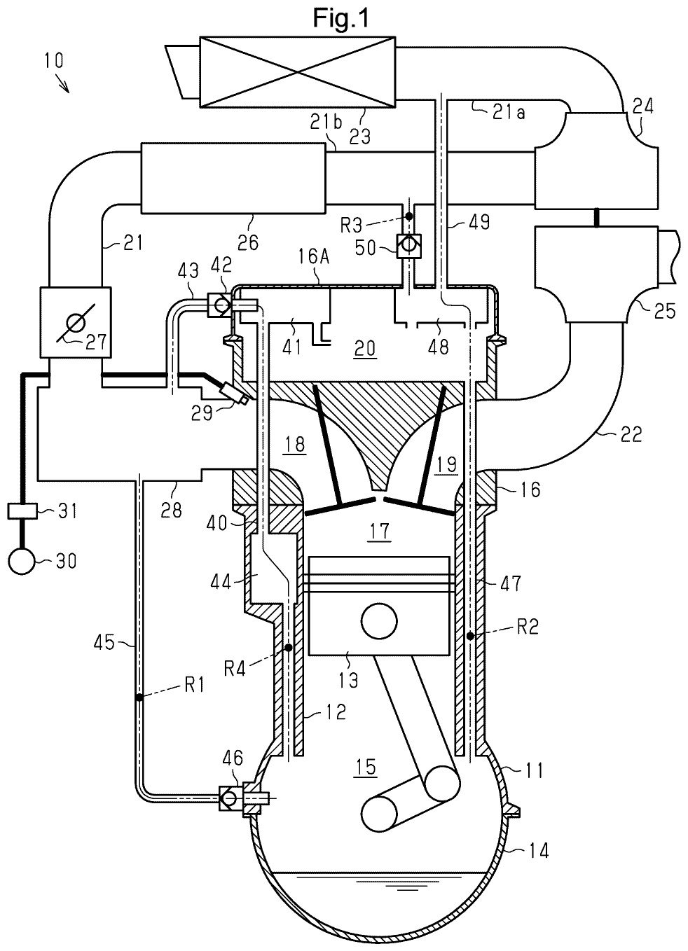

FIGS. 1 to 3 illustrate in detail an embodiment of a ventilation system for a forced-induction engine.

### Configuration of Forced-Induction Engine 10

The configuration of the forced-induction engine 10 will be described with reference to FIG. 1. The forced-induction engine 10 employs the ventilation system of the present embodiment. The forced-induction engine 10 shown in FIG. 1 is a hydrogen engine that uses hydrogen as fuel. In a hydrogen engine, combustible hydrogen may be contained in the blow-by gas. Therefore, the ventilation performance of the blow-by gas of the hydrogen engine is required to be higher than that of the gasoline engine or the diesel engine.

The forced-induction engine 10 includes a cylinder block 11. Cylinders 12 are formed inside the cylinder block 11. FIG. 1 shows only one of the cylinders 12. A piston 13 is reciprocatably accommodated in each of the cylinders 12. A combustion chamber 17 for burning hydrogen is formed above the piston 13 inside the cylinder 12 in the drawing. An oil pan 14 that stores oil is attached to the lower part of the cylinder block 11. A crankcase 15 is formed below the cylinder 12 inside the cylinder block 11. A cylinder head 16 is mounted on the upper part of the cylinder block 11. Inside the cylinder head 16, an intake port 18 and an exhaust port 19 are formed individually for each cylinder 12. A head cover 16A is attached to an upper portion of the cylinder head 16. A valve chamber 20 for accommodating a valve mechanism is formed in an upper portion of the interior of the cylinder head 16 covered by the head cover 16A.

The forced-induction engine 10 includes an intake passage 21, which is a passage for introducing air into the combustion chamber 17, and an exhaust passage 22, which is a passage for discharging exhaust gas from the combustion chamber 17. The intake passage 21 includes an air cleaner 23 that filters dust or the like from the air. A compressor 24 is provided in a section of the intake passage 21 that is downstream of the air cleaner 23. A turbine 25 is provided in the exhaust passage 22. The compressor 24 and the turbine 25 constitute a turbocharger. That is, the intake passage 21 includes an upstream intake portion 21a upstream of the compressor 24 and a downstream intake portion 21b downstream of the compressor 24. An intercooler 26 is provided in the downstream intake portion 21b. The intercooler 26 is a heat exchanger for cooling the air heated to a high temperature by the compression by the compressor 24. A throttle valve 27 is provided in a section of the intake passage 21 that is downstream of the intercooler 26. The throttle valve 27 adjusts the flow rate of air sent to the combustion chamber 17 through the intake passage 21. An intake manifold 28 is provided in a section downstream of the throttle valve 27. The intake passage 21 is branched for each cylinder 12 in the intake manifold 28. The intake manifold 28 is connected to each combustion chamber 17 through the intake port 18.

Further, the forced-induction engine 10 includes an injector 29, a hydrogen tank 30, and a pressure regulator 31. The pressure regulator 31 regulates the pressure of hydrogen in the hydrogen tank 30 and supplies it to the injector 29. The injector 29 injects hydrogen into the air used for combustion in the combustion chamber 17. The injector 29 of FIG. 1 is provided to inject hydrogen into the intake port 18. Alternatively, the injector 29 may be provided to inject hydrogen into the combustion chamber 17.

### Configuration of Ventilation System

Next, a configuration of a ventilation system of the present embodiment applied to the forced-induction engine 10 will be described. The ventilation system is configured to ventilate the blow-by gas in the crankcase 15 by discharging the blow-by gas in the crankcase 15 to the intake air. The ventilating system of the present embodiment includes a first passage R1, a second passage R2, a third passage R3, and a fourth passage R4.

The first passage R1 connects the downstream intake portion 21b to the inside of the crankcase 15. In the ventilating system of the present embodiment, the connecting portion of the first passage R1 connected to the intake passage 21 is connected to the intake manifold 28. The first passage R1 is provided with a first PCV hose 45 and a first PCV valve 46. The first PCV hose 45 connects the crankcase 15 to the intake manifold 28. The first PCV valve 46 allows gas to flow from the intake passage 21 to the inside of the crankcase 15 through the first passage R1. On the other hand, the first PCV valve 46 restricts the flow of gas from the crankcase 15 toward the intake passage 21 through the first passage R1. The first PCV valve 46 is provided at a connection portion of the first PCV hose 45 connected to the crankcase 15.

The second passage R2 connects the upstream intake portion 21a to the inside of the crankcase 15. The second passage R2 includes an oil return passage 47, the valve chamber 20, a first oil separator 48, and a second PCV hose 49. The oil return passage 47 connects the valve chamber 20 to the crankcase 15 by passing through the inside of the cylinder block 11 and the cylinder head 16. The oil return passage 47 functions as a passage for returning oil from the valve chamber 20 to the oil pan 14. Further, the oil return passage 47 also functions as a passage for circulating gas between the valve chamber 20 and the crankcase 15. The first oil separator 48 separates oil mist in the blow-by gas flowing through the second passage R2. The first oil separator 48 is provided inward of the head cover 16A. In the present embodiment, the first oil separator 48 corresponds to the oil separators provided in the second passage R2. The second PCV hose 49 connects a section of the upstream intake portion 21a that is downstream of the air cleaner 23 to the first oil separator 48.

The third passage R3 connects the downstream intake portion 21b to the first oil separator 48. In the case of the ventilating system of the present embodiment, the connecting portion of the third passage R3 connected to the intake passage 21 is connected to a section of the downstream intake portion 21b that is upstream of the intercooler 26. The third passage R3 is constituted by a hose, a pipe, or the like. A check valve 50 is provided in the third passage R3. The check valve 50 restricts the flow of gas from the first oil separator 48 toward the intake passage 21.

The fourth passage R4 connects a section of the intake passage 21 that is downstream of the throttle valve 27 to the inside of the crankcase 15. The fourth passage R4 includes a blow-by gas passage 40, a second oil separator 41, a second PCV valve 42, a third PCV hose 43, and a third oil separator 44. The second and third oil separators 41 and 44 separate oil mist from the blow-by gas flowing through the fourth passage R4. The second oil separator 41 are attached to the inner side of the 16A of the head cover. The blow-by gas passage 40 connects the inside of the crankcase 15 to the second oil separator 41 by passing through the inside of the cylinder block 11 and the cylinder head 16. The third oil separator 44 is provided in the blow-by gas passage 40 in the cylinder block 11. The third PCV hose 43 connects the second oil separator 41 to the intake manifold 28. The second PCV valve 42 restricts the flow of gas from the intake passage 21 toward the crankcase 15 through the fourth passage R4. The second PCV valve 42 is provided at a connection portion of a third PCV hose 43 connected to the second oil separator 41.

In the case of the ventilating system of the present embodiment, the minimum flow passage area S1 of the first passage R1 is larger than the minimum flow passage area S3 of the third passage R3 (S1>S3). The minimum flow passage area S2 of the second passage R2 is larger than the minimum flow passage area S1 of the first passage R1 (S2>S1). These minimum flow passage areas each represent the flow passage area of a section in which the gas flow passage area is minimum in each passage. Such a magnitude relation (S1>S2>S3) among the minimum flow passage areas S2, S1, S3 can be realized by changing the inner diameters of the hoses constituting the respective passages. In addition, it is possible to realize the magnitude relationship among the minimum flow passage areas S1, S2, and S3 as described above by providing a throttle in each of the passages (R1, R2, and R3).

### Operation and Advantages of Embodiment

The operation and effects of the ventilation system for the forced-induction engine 10 of the present embodiment will be described.

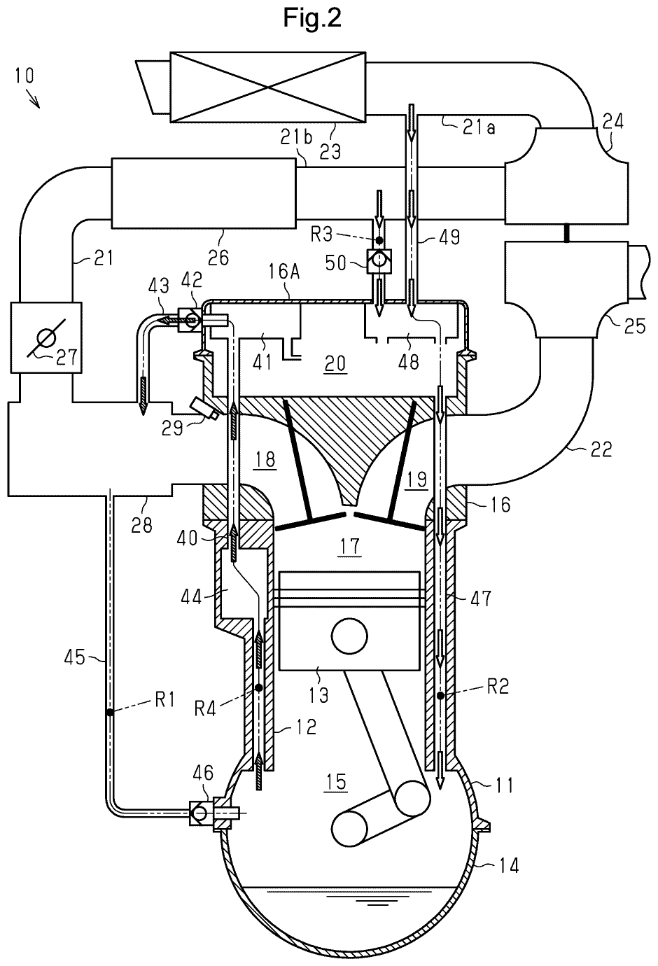

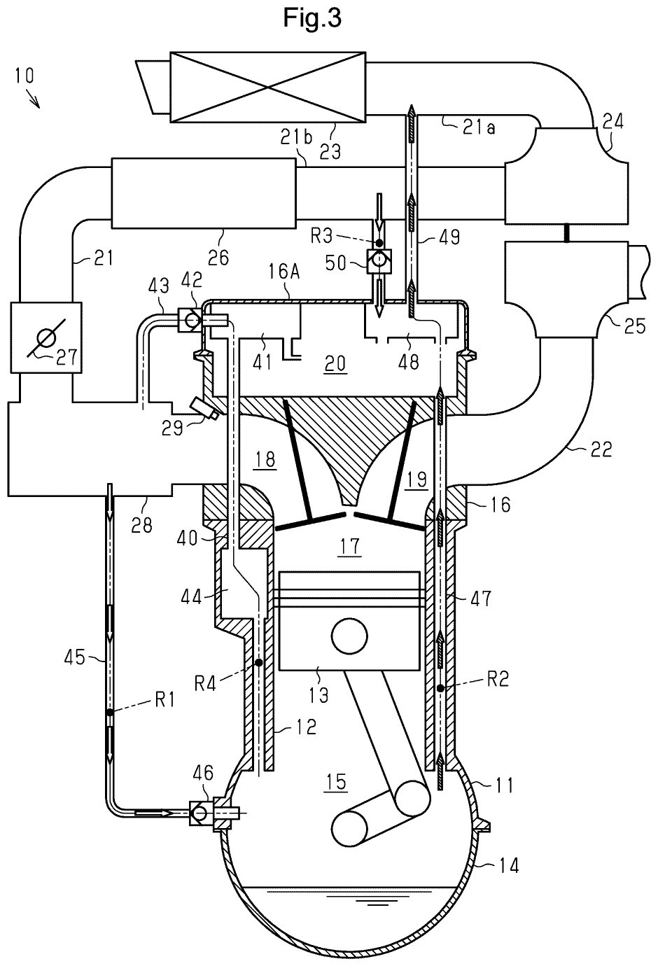

FIG. 2 shows the flow of gas in the ventilation system during naturally aspirated operation of the forced-induction engine 10. The white arrows shown in FIGS. 2 and 3 indicate the flow direction of air in the ventilation system. The hatched arrows indicate the flow direction of the blow-by gases in the ventilation system. During the natural aspiration operation, the section of the intake passage 21 that is downstream of the throttle valve 27 has a negative pressure due to throttling by the throttle valve 27. Therefore, for example, the pressure in the intake manifold 28 is lower than the atmospheric pressure. The crankcase 15 is connected to the negative pressure intake manifold 28 through the fourth passage R4. The second PCV valve 42 provided in the fourth passage R4 allows the gas to flow from the crankcase 15 toward the intake passage 21. Thus, the blow-by gas in the crankcase 15 is sucked into the intake manifold 28 through the fourth passage R4. Air is introduced into the crankcase 15 through the second passage R2 and the third passage R3.

FIG. 3 shows the gas flow in the ventilation system during the forced-induction operation of the forced-induction engine 10. During the forced-induction operation, the downstream intake portion 21b has a positive pressure. That is, the pressure in the downstream intake portion 21b is higher than the atmosphere. Air is introduced into the crankcase 15 from the positive pressure intake manifold 28 through the first passage R1. The blow-by gas in the crankcase 15 is sent to the upstream intake portion 21a through the second passage R2 by the introduced air.

When the blow-by gas is sent out to the upstream intake portion 21a through the second passage R2, oil is separated from the blow-by gas in the first oil separator 48 of the second passage R2. If the temperature inside the first oil separator 48 is low, moisture in the blow-by gas may be mixed into the oil separated by the first oil separator 48. As a result, an emulsion may be generated.

In contrast, the ventilating system of the present embodiment is provided with the third passage R3. The third passage R3 connects the downstream intake portion 21b to the first oil separator 48. In the downstream intake portion 21b during the forced-induction operation, high-temperature air exists due to adiabatic compression by the compressor 24. The high-temperature air is introduced into the first oil separator 48 through the third passage R3, whereby the temperature in the first oil separator 48 rises. The higher the ambient temperature, the less likely an emulsion will be formed. Also, the higher the ambient temperature, the lower the viscosity of the finished emulsion. Further, since the air is introduced into the first oil separator 48 through the third passage R3, the partial water vapor pressure of the blow-by gas that has been introduced into the first oil separator 48 is reduced. When the water vapor partial pressure of the blow-by gas decreases, the dew point decreases. Therefore, generation of condensed water in the first oil separator 48 is suppressed. Therefore, the formation of an emulsion is suppressed.

According to the ventilation system for the forced-induction engine 10 of the present embodiment described above, the following effects can be achieved.
(1) The ventilation system of the present embodiment includes the first passage R1, the second passage R2, the third passage R3, and check valve 50, which are described below. The first passage R1 connects the downstream intake portion 21b to the crankcase 15. The second passage R2 connects the upstream intake portion 21a to the crankcase 15. The third passage R3 connects the downstream intake portion 21b to the first oil separator 48 provided in the second passage R2. The check valve 50 restricts the flow of gas from the first oil separator 48 to the intake passage 21 through the third passage R3. In such a ventilation system, air having a high temperature due to compression by the compressor 24 is introduced into the first oil separator 48 during the forced-induction operation. The first oil separator 48 is heated by the introduction of the high-temperature air. Therefore, the generation of emulsion in the first oil separator 48 is suppressed. Therefore, the ventilation system of the present embodiment suppresses the occurrence of emulsion.
(2) The third passage R3 connects the section of the downstream intake portion 21b that is upstream of the intercooler 26 to the first oil separator 48. Therefore, for example, air having a higher temperature can be introduced into the first oil separator 48 than in a case where air in the section of the downstream intake portion 21b that is downstream of the intercooler 26 is introduced into the first oil separator 48. Therefore, the effect of suppressing the occurrence of emulsion is high.
(3) The minimum flow passage area S1 of the first passage R1 is larger than the minimum flow passage area S3 of the third passage R3 (S1>S3). Further, the minimum flow passage area S2 of the second passage R2 is larger than the minimum flow passage area S1 of the first passage R1 (S2>S1). If, during a forced-induction operation of the forced-induction engine 10, the flow rate of gas entering the crankcase 15 through the first passage R1 continuously exceeds the flow rate of gas discharged from the crankcase 15 through the second passage R2, there is a risk that the internal pressure of the crankcase 15 may increase. On the other hand, by setting the minimum flow passage area of each passage as described above, an increase in the internal pressure of the crankcase 15 is suppressed.

### Other Embodiments

The above-described embodiment may be modified as follows. The above-described embodiment and the following modifications can be implemented in combination with each other as long as there is no technical contradiction.

### Third Passage R3

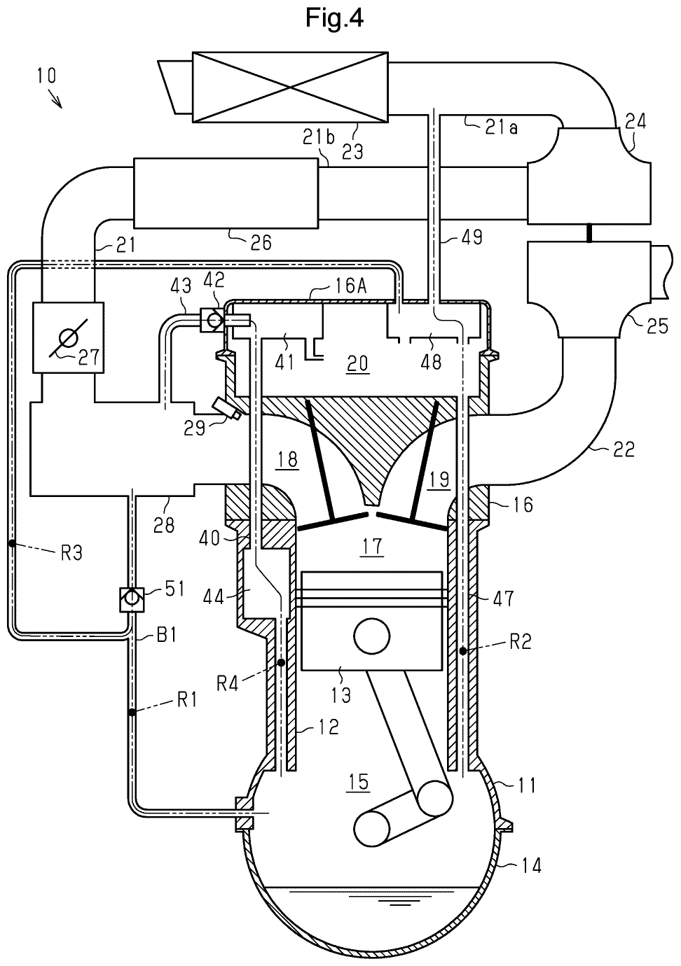

In the ventilating system of the above-described embodiment of FIGS. 1 to 3, the third passage R3 is connected to the section of the downstream intake portion 21b that is upstream of the intercooler 26. The coupling portion of the third passage R3 coupled to the intake passage 21 may be connected to the downstream intake portion 21b. Therefore, the coupled portion of the third passage R3 coupled to the intake passage 21 may be connected to the section of the downstream intake portion 21b that is downstream of the intercooler 26. FIG. 4 shows an example. The air that has passed through the intercooler 26 is introduced into the first oil separator 48 during the forced-induction operation of this modified example. Although the introduced air is cooled by the intercooler 26, the temperature thereof is higher than that of the outside air. Therefore, the first oil separator 48 can be heated.

The third passage R3 may be configured as shown in FIG. 4. In the case of the ventilating system shown in FIG. 4, the third passage R3 branches from the first passage R1. That is, the third passage R3 is connected to the section of the downstream intake portion 21b that is downstream of the intercooler 26 through the first passage R1. The first passage R1 has a branching position B1 branching from the third passage R3. That is, the third passage R3 extends from the downstream intake portion 21b along the first passage R1, branches off from the first passage R1 at the branching position B1, and is connected to the first oil separator 48. The check valve 51 of the ventilating system of FIG. 4 is provided in the first passage R1 between the branching position B1 and the intake passage 21. In the ventilation system of FIG. 4, a single check valve 51 performs the functions of the two valves in the ventilation system of FIGS. 1-3. That is, the check valve 51 of FIG. 4 functions as both the check valve 50 and the first PCV valve 46 of FIGS. 1 to 3.

### Others

The first oil separator 48 may be provided at a portion different from the inside of the valve chamber 20.

The magnitude relationship among the minimum flow passage areas S1, S2, and S3 of the first passage R1, the second passage R2, and the third passage R3 may be appropriately changed.

When it is not necessary to ventilate the crankcase 15 during the natural aspiration operation, the fourth passage R4, the second PCV valve 42, the second oil separator 41, the third oil separator 44, and the like may be omitted.

The ventilation system of the above-described embodiment and modifications thereof can also be applied to a forced-induction engine using a fuel other than hydrogen.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A ventilation system for a forced-induction engine, the ventilation system comprising:
a first passage that connects an intake passage of the forced-induction engine to a crankcase, the forced-induction engine including a compressor provided in the intake passage, the intake passage including an upstream intake portion upstream of the compressor and a downstream intake portion downstream of the compressor, a throttle valve being provided in the downstream intake portion, the first passage connecting the downstream intake portion to the crankcase to ventilate the crankcase;
a second passage that connects the upstream intake portion to the crankcase;
an oil separator that is provided in the second passage;
a third passage that connects the downstream intake portion to the oil separator; and
a check valve that restricts a flow of gas from the oil separator toward the downstream intake portion through the third passage.

2. The ventilation system for the forced-induction engine according to claim 1, wherein
a minimum flow passage area of the first passage is larger than a minimum flow passage area of the third passage, and
a minimum flow passage area of the second passage is larger than the minimum flow passage area of the first passage.

3. The ventilation system for the forced-induction engine according to claim 1, wherein
the forced-induction engine includes an intercooler provided in a section of the downstream intake portion that is upstream of the throttle valve, and
the third passage is connected to a section of the downstream intake portion that is upstream of the intercooler.

4. The ventilation system for the forced-induction engine according to claim 1, wherein
the third passage is connected to the downstream intake portion through the first passage,
the first passage includes a branching position at which the first passage branches from the third passage,
the third passage is configured to branch from the first passage at the branching position and then to be connected to the oil separator, and
the check valve is provided to be closer to the intake passage than the branching position is.

5. The ventilation system for the forced-induction engine according to claim 1, wherein fuel for the forced-induction engine is hydrogen.
